(19) United States
(12) Patent Application Publication
(10) Pub. No.: US 2016/0297405 A1
(43) Pub. Date: Oct. 13, 2016

(54) WIPER BLADE FOR WINDSCREEN WIPER

(71) Applicant: VALEO SYSTEMES D'ESSUYAGE, Le Mesnil Saint Denis (FR)

(72) Inventors: FRÉDÉRIC BRETAGNOL, Issoire (FR); AMÉLIE NOEL, Cournon d'Auvergne (FR)

(73) Assignee: VALEO SYSTEMES D'ESSUYAGE, Le Mesnil Saint Denis (FR)

(21) Appl. No.: 15/086,195

(22) Filed: Mar. 31, 2016

(30) Foreign Application Priority Data
Apr. 10, 2015 (FR) 1553165

(51) Int. Cl. B60S 1/38

(52) U.S. Cl. CPC B60S 1/38; B60S 2001/3829

(57) ABSTRACT

The invention relates to a wiper blade (10) for windscreen wiper, comprising a substrate made of material based on elastomer(s) covered at least partly by a coating having at least three superposed layers, referred to respectively as the inner layer, intermediate layer and outer layer, the inner layer forming a bonding primer for bonding to the intermediate layer and comprising a lubricating filler content of substantially zero and the intermediate layer having a non-zero lubricating filler content that is lower than that of the outer layer. The invention also relates to a process for obtaining such a blade (10).

The present invention relates to a wiper blade for a windscreen wiper, and also to a process for manufacturing such a blade.

Motor vehicles are currently equipped with windscreen wiper systems for washing the windscreen and avoiding disruption to the driver's view of his surroundings. These windscreen wipers are conventionally driven by arms that perform an angular back-and-forth movement and that comprise elongated wipers, themselves bearing wiper blades made of an elastic material. These blades rub against the windscreen and carry away the water by transporting it outside of the driver's field of view. The wipers are produced in the form either, in a conventional version, of articulated yokes that hold the wiper blade at several discrete locations, or, in a more recent version known as a “flat blade”, of a semi-rigid assembly that holds the wiper blade over its entire length.

A wiper blade is in general made of rubber and therefore has a low hardness. In order to increase its durability, that is to say to ensure an effective wiping over a long period, it is known to cover a wiper blade with a relatively hard coating.

Another drawback of a wiper blade made of rubber is that it generates noise nuisance, especially squeaking, when it is moved over the windscreen, in particular when the latter is not very wet. In order to overcome this drawback, it is known to add lubricating fillers to the coating in order to reduce the friction coefficient of the blade on the windscreen and thus reduce the noise nuisance.

However, the coated wiper blades of the current art have drawbacks. The Applicant has indeed observed that too hard a coating has a tendency to separate from the blade by delamination. Solutions to these problems have already been proposed, which are not however completely satisfactory.

Lastly, another problem of the wiper blades is that the coatings used are based on solvents that are relatively harmful and not very environmentally friendly.

There is therefore a need for a wiper blade coating that makes it possible to improve the durability of the blade and to reduce the noise nuisance during use, while limiting the risk of delamination of this coating.

The invention provides a simple and effective solution to this need.

For this purpose, the invention proposes a wiper blade for windscreen wiper, comprising a substrate made of material based on elastomer(s) covered at least partly by a coating having at least three superposed layers, referred to respectively as the inner layer, intermediate layer and outer layer, the inner layer forming a bonding primer for bonding to the intermediate layer and comprising a lubricating filler content of substantially zero, preferably zero, and the intermediate layer having a non-zero lubricating filler content that is lower than that of the outer layer.

The expression “inner layer” is understood to mean a layer preferably directly in contact with the substrate and/or with the intermediate layer, preferably directly in contact with the substrate and with the intermediate layer.

The content of lubricating fillers of each layer is determined on the basis of the total weight of the dry material in the layer.

In other words, the increasing content of lubricating fillers from one layer to the next, from the inside to the outside of the coating, makes it possible to progressively increase the hardness of each layer. The hold between the layers is improved thereby since the difference in hardness between two adjacent layers is smaller. Thus layers are obtained that have a good adhesion to one another and the risk of delamination of the coating is limited. Furthermore, the presence of lubricating fillers in the coating makes it possible to reduce the frictions during the rubbing of the blade on the windscreen and thus to reduce the noise nuisance during use,

According to various embodiments of the invention, which could be taken together or separately:
said lubricating fillers are selected from particles (such as microparticles, nanoparticles, nanotubes) of graphite, of molybdenum disulphide (MoS₂), of talc, of polymers, of fullerene, of carbon, of colloidal silica and mixtures thereof,
said polymers may be selected from polyethylene, ultra high molecular weight polyethylene (UHMWPE), polypropylene, fluoropolymers, polymers and copolymers based on acrylates, on diallyl phthalates, on an epoxy unit, on vinyl acetate/ethylene, on urea-formaldehyde, on phenols, on amide, on carbonate, on ethylene terephthalate, on imide, on amide-imide, on styrene, on sulphone, on ether sulphone, on urethane, on vinyl chloride, on silicone, and mixtures thereof,
the size of the microparticles (such as microparticles of graphite, of molybdenum disulphide (MoS₂) or of talc) is between 1 and 30 μm,
the size of the nanoparticles and of the nanotubes is less than 1 μm,
preferably, said fillers are graphite powder,
the content of lubricating fillers in the intermediate layer is between 40 and 75% by dry weight (relative to the dry weight of this layer),
the content of lubricating fillers in the outer layer is between 70 and 100% by dry weight (relative to the dry weight of this layer),
the thickness of the inner layer is between 0.05 μm and 4 μm,
the thickness of the intermediate layer is between 1 and 5 μm,
the thickness of the outer layer is greater than 2 μm,
the inner layer, the intermediate layer, and optionally the outer layer, comprise at least one binder,
said binder(s) comprise(s) a polymer or a mixture of polymers,
the polymer(s) (binders) is (are) selected from resins, acrylic derivatives, styrene-acrylic derivatives, acrylonitriles and derivatives thereof, vinylstyrene derivatives, polyurethanes of ester or ether type and derivatives thereof and polyvinyl chloride (PVC),
said binder(s) is (are) identical or different in each of said layers,
the weight ratio of the lubricating fillers to the binder of the intermediate layer is between 1 and 2.5,
the weight ratio of the lubricating fillers to the binder of the outer layer is greater than 2.5,
the inner layer additionally comprises adhesive particles,
said adhesive particles are particles having a core-shell structure,
said adhesive particles are particles functionalized at the surface with reactive chemical functions. These reactive chemical functions are for example epoxy, acrylic, vinyl or amino functions or any other chemical functions capable of reacting both with the material of the blade and with at least one component of the intermediate layer, such as the binder,
said adhesive particles are functionalized silica particles or particles of polymeric nature,
the inner layer comprises adhesive particles in combination with a binder,
said adhesive particles are microparticles with a diameter between 1 and 50 μm and/or nanoparticles with a diameter of less than 1 μm,
the inner layer comprises at least one adhesion promoting agent and/or at least one mechanical reinforcing agent,
said adhesion promoting agent(s) and/or mechanical reinforcing agent(s) are selected from carbon black, silica or chalk and also derivatives and/or mixtures thereof,
the inner layer additionally comprises at least one crosslinking agent,
said crosslinking agent(s) is (are) of melamine, isocyanate, epoxy or organosilane type,
the outer layer comprises at least one binder,
said adhesive agent(s) comprise(s) a polymer or a mixture of polymers, selected from resins, acrylic derivatives, styrene-acrylic derivatives, acrylonitriles and derivatives thereof, vinylstyrene derivatives, polyurethanes of ester or ether type and derivatives thereof and polyvinyl chloride (PVC),
the inner layer has an elongation at break of greater than 20%,
the inner layer has a Young's modulus at 1% elongation of less than 5 MPa,
the intermediate layer has a Young's modulus at 1% elongation of greater than 25 MPa.

The invention also relates to a process for manufacturing a wiper blade for windscreen wiper, preferably from a pair of wiper blades, said process comprising a step of coating, at least partly, said blade or pair, comprising the substeps that consist in depositing an inner layer on at least one portion of the blade or pair, depositing an intermediate layer on at least one portion of the inner layer and depositing an outer layer on at least one portion of the intermediate layer, the inner layer forming a bonding primer and comprising a lubricating filler content of substantially zero, preferably zero, the intermediate layer having a non-zero lubricating filler content that is lower than that of the outer layer.

According to various embodiments of the invention, which could be taken together or separately:
at least one of the layers deposited is in the aqueous phase,
a layer (intermediate or outer layer) is applied to another layer (lower or intermediate layer) when this other layer has hardened and/or is dry to the touch,
a layer (intermediate or outer layer) is applied to another layer when this other layer has not hardened and/or is not yet dry to the touch, these layers being intended to harden/dry together,
at least one of the layers is applied to the blade or the pair of wiper blades, before or after vulcanization of the blade or of the pair of wiper blades,
at least one of the layers is applied to a hot blade or hot pair of wiper blades,
said layers are applied by brushing, dip-coating, spraying or electrostatic coating,
said process comprises a preliminary step of surface preparation of the blade or of the pair of wiper blades,
said preparation step is a plasma treatment, a halogenation and/or an ion implantation,
said process comprises at least one step of curing the blade or the pair of wiper blades,
the temperature of said curing is between 100 and 250° C. and is preferably around 140° C.,
the duration of said curing is between 0.1 and 5 minutes and is preferably around 30 seconds,
said wiper blade or said wiper blades of the pair respectively comprise a lip connected to a hinge, said intermediate layer being applied only to said lip,
said intermediate layer is applied only to said lip by brushing or by using a mask that covers the rest of the blade or pair,
the layers are applied to a pair of wiper blades,
said pair is cut in order to form two wiper blades,
at least one of the inner, intermediate and outer layers is applied to said surface of said pair before cutting said pair,
said pair is not pre-split before the deposition of the coating.

The invention also relates to a windscreen wiper comprising a blade as described above.

The invention finally relates to a wiping system comprising such a windscreen wiper.

The invention will be better understood, and other objectives, details, features and advantages thereof will appear more clearly in the course of the detailed explanatory description that follows of at least one embodiment of the invention given by way of purely illustrative and nonlimiting example, with reference to the appended schematic drawings.

In these drawings:

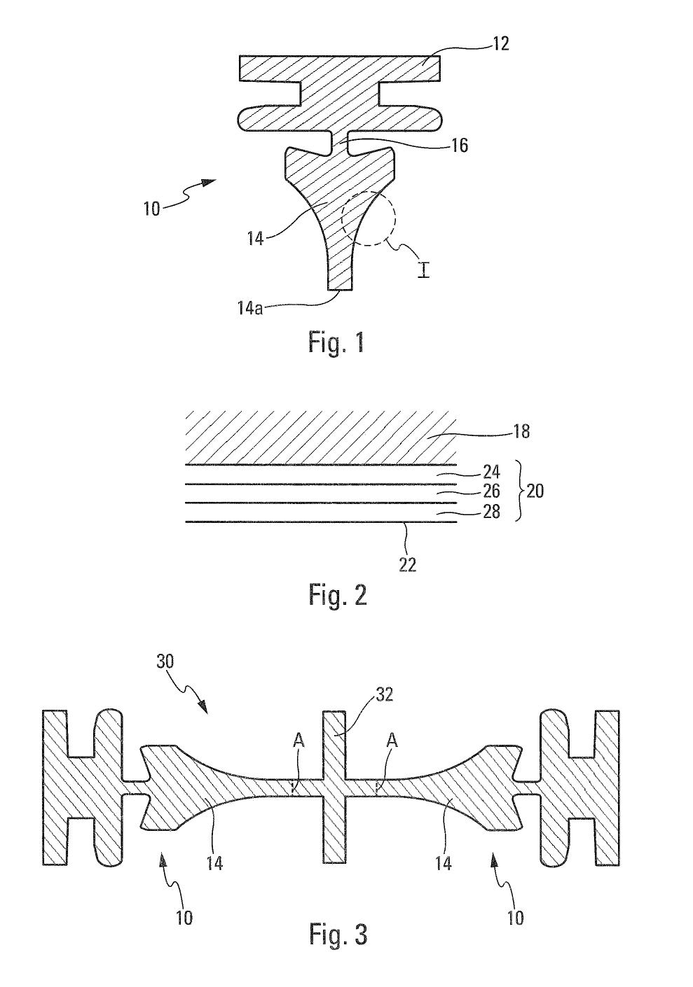

FIG. 1 is a schematic view of a wiper blade according to one embodiment of the invention,

FIG. 2 is an enlargement of the detail I from FIG. 1, and

FIG. 3 is a schematic view of a pair of wiper blades.

Reference is firstly made to FIG. 1 which shows a wiper blade 10 of a windscreen wiper, this blade 10 having an elongated shape and being intended to be borne by a body of the wiper (not represented). The blade 10 comprises a heel 12 which enables the blade tend to be held in the body of the wiper and which is connected by a hinge 16 to a lip 14 which is intended to be in contact with a windscreen with a view to the wiping thereof. The hinge 16 is formed by a thin strip of material that gives the blade a certain flexibility and allows a reversal thereof during a change in the direction of movement of the wiper.

The lip 14, the hinge 16 and heel 12 of the blade 10 are formed from a single part, preferably from a material based on elastomer(s). The surface of the material of the blade 10 may be treated by plasma, halogenation and/or ion implantation. This blade 10 therefore forms a substrate for the coating 20 according to the invention.

FIG. 2 represents an enlargement of the wiper blade 10 from FIG. 1. The outer surface of the blade 10 is covered with a multilayer coating according to the invention, the reference 18 denoting the material based on elastomer(s) of the blade. The contact surface of the blade 10 on the windscreen is thus defined by the outer surface 22 of the coating 20.

In the embodiment represented, the coating 20 comprises three superposed layers, respectively the inner layer 24, intermediate layer 26 and outer layer 28. The inner layer 24 forms a bonding primer and comprises a lubricating filler content of substantially zero. The intermediate layer 26 has a non-zero lubricating filler content that is less than that of the outer layer 28.

The lubricating filler(s) make(s) it possible to lower the friction coefficient of the wiper blade 10. They may be selected from particles (such as microparticles, nanoparticles, nanotubes) of graphite, of molybdenum disulphide (MoS₂), of talc, of polymers, of fullerene, of carbon, of colloidal silica and mixtures thereof. Said polymers forming the particles may be selected from polyethylene, ultra high molecular weight polyethylene (UHMWPE), polypropylene, fluoropolymers, polymers and copolymers based on acrylates, on diallyl phthalates, on an epoxy unit, on vinyl acetate/ethylene, on urea-formaldehyde, on phenols, on amide, on carbonate, on ethylene terephthalate, on imide, on amide-imide, on styrene, on sulphone, on ether sulphone, on urethane, on vinyl chloride, on silicone, and mixtures thereof.

Preferably, the lubricating filler is graphite powder.

Preferably, the content of lubricating fillers in the intermediate layer 26 is between 40 and 75% by dry weight relative to the dry weight of the intermediate layer, and that in the outer layer 28 is between 70 and 100% by dry weight relative to the dry weight of the outer layer. The hardness of a layer is in particular a function of its lubricating filler content, the higher this content, the greater the hardness of the layer. The outer layer thus has a hardness greater than that of the inner layer. The difference in content between the inner and outer layers is not however large, which means the difference in hardness between these layers is not large either. This makes it possible to provide a good adhesion of the outer layer, and also of the intermediate layer. Furthermore, due to the substantially zero filler content of the inner layer, this layer has a low hardness and thus a good adhesion to the material of the blade and thus provides a bonding primer function that limits the risk of delamination of the coating.

Each of the layers applied (24, 26, 28) may also comprise one or more binders. The binder(s) comprise(s) a polymer or a mixture of polymers, the role of which is to bind together the lubricating fillers, such as graphite. It is incorporated in the form of a suspension, dispersion or powder depending on the method of application of the coating 20. The polymer may be a homopolymer or a copolymer. These polymers may be used alone or as mixtures depending on their compatibility or the desired final properties.

The polymer preferably has a glass transition temperature below or equal to 0° C., preferably below or equal to −20° C. in order to retain the flexibility properties of the film of the coating at low temperature. Nevertheless, in certain cases, one or more polymers with a positive glass transition temperature (that may be above 50° C.) may be added to the formulation to improve the abrasion resistance properties and other properties such as the wear.

The polymer(s) is (are) selected from resins, acrylic derivatives, styrene-acrylic derivatives, acrylonitriles and derivatives thereof, vinylstyrene derivatives, polyurethanes of ester or ether type and derivatives thereof and polyvinyl chloride (PVC). The binder may also comprise a fluoroelastomer, silicones, siloxanes, elastomeric latices, and powders of polyamide, of polyethylene or polypropylene. The binder(s) may be identical or different in each of the layers (24, 26, 28).

Preferably, aqueous-based binders are used. An aqueous phase is understood to mean a composition that comprises a content of organic solvents of less than or equal to 10% by total weight of the composition, or even less than or equal to 5%, or even equal to 0%.

The binder may also comprise at least one crosslinking agent, preferably of melamine, isocyanate, epoxy or organosilane type, in order to confer increased mechanical strength and chemical resistance properties on the coating on the one hand, but also to provide a covalent chemical bond between two successive layers. Indeed, crosslinking may be formed between two successive layers if these layers contain at least one polymer that is reactive with the crosslinking agent. For example, a crosslinking agent of isocyanate type may react both with the alcohol functions of a polyurethane and with the acid functions of an acrylic resin.

The binder may also comprise any other chemical element that makes it possible to ensure the cohesion of the layers with one another, especially binding agents of epoxy-silane type for example.

Each of the layers applied (24, 26, 28) may also comprise one or more additives, such as dispersion wetting agents, thickeners, antifoams, preservatives, waxes, etc. The dispersion wetting agents, such as for example polyacrylates, facilitate the incorporation of the lubricating fillers into the binder. The thickeners, such as for example modified celluloses, modified urethane polymers or polyacrylates, make it possible to prevent the sedimentation thereof. The waxes, such as polyethylene waxes for example, make it possible to improve the impermeability of the coating and also to reduce the frictions and improve the abrasion resistance.

Advantageously, the inner layer 24 comprises various additives, also referred to as adhesion promoting agents and/or mechanical reinforcing agents, in order to enable a good adhesion of the coating 20 to the wiper blade 10 and to improve the mechanical properties of the wiper blade. These agents may be carbon black, silica, chalk, and also derivatives and/or mixtures thereof.

In certain embodiments according to the invention, the inner layer may be a commercial bonding primer, especially an aqueous-based primer, such as Daotan® TW 6431 sold by Cymel or Resilon® 4020 sold by Whitford.

In other embodiments according to the invention, the inner layer 24 may additionally comprise adhesive particles. These may be microparticles with a diameter between 1 and 50 μm and/or nanoparticles with a diameter of less than 1 um. Said particles have reactive functions at the surface that make it possible to strengthen the bond between the inner layer 24 and the intermediate layer 26. They may be epoxy, acrylic, vinyl or amino functions or any other chemical functions capable of reacting both with the material of the blade 10 and with at least one component of the intermediate layer, such as the binder. Said particles may especially be functionalized silica particles or particles of polymeric nature. The functionalization thereof may be carried out by any process that enables the functionalization of polymer and/or mineral particles, for example via a plasma pretreatment.

In these embodiments, the inner layer 24 may only comprise adhesive particles deposited directly on the blade 10.

In yet other embodiments according to the invention, the inner layer 24 may also be a UV-crosslinkable varnish. This will especially contain reactive functions of alcohol and/or acid type capable of enabling a covalent attachment with the intermediate layer 26, for example by heat activation.

The inner layer 24 may also comprise a crosslinking agent, preferably of melamine, isocyanate or epoxy type, in order to improve the mechanical and chemical properties of the blade 10.

In order to limit the propagation into the air of the lubricating fillers, which may be volatile, the outer layer 28 may comprise a binder. This may be identical to the binder of the intermediate and outer layer. The adhesive agents used generally comprise a polymer or a mixture of polymers, selected from resins, acrylic derivatives, styrene-acrylic derivatives, acrylonitriles and derivatives thereof, vinylstyrene derivatives, polyurethanes of ester or ether type and derivatives thereof and polyvinyl chloride (PVC).

Generally, the inner layer 24 and intermediate layer 26 should not exceed a certain thickness in order to guarantee a good wiping quality. Thus, the thickness of the inner layer 24 should not exceed 4 μm for example, and is preferably between 0.05 μm and 4 μm. The thickness of the intermediate layer 26 does not exceed 5 μm for example, and is preferably between 1 and 5 μm. The thickness of the outer layer is preferably greater than 2 μm.

In the embodiments in which the inner layer 24 comprises adhesive particles, the thickness of this layer will depend on the size of the particles and also on the desired adhesion properties.

In order to prevent the appearance of cracking or delamination of the coating 20 when the wiper blade 10 is subjected to rubbing over the windscreen, the composition and the thickness of the layers of the coating 20 are selected so that:
the inner layer 24 has an elongation at break of greater than 20% and a Young's modulus at 1% elongation of less than 5 MPa, and
the intermediate layer 26 has a Young's modulus at 1% elongation of greater than 25 MPa.

The coating 20 may cover all or part of the wiper blade 10. In particular, the end 14a of the lip (cf. FIG. 1) may not be covered with coating 20 in order to allow a good wiping of the windscreen. Considering the stiffness of the various layers, the coating 20 may be free of intermediate layer 26 at the hinge 16. Indeed, in order to be able to retain a certain flexibility and allow the reversal of the lip 14 over the surface to be wiped, especially during the change in direction of the wiper at the reversal points, the hinge 16 comprises a coating with only two layers: an inner layer comprising a lubricating filler content of substantially zero and an outer layer comprising lubricating fillers. Despite the absence of intermediate layer in the coating of the hinge, the risk of delamination of this coating is low due to the fact that this coating is not in contact with the surface to be wiped and is therefore not stressed.

The wiper blade 10 according to the invention may be obtained by a manufacturing process comprising a step of coating, at least partly, said blade. This coating step may comprise the substeps that consist in:
depositing an inner layer 24 on at least one portion of the blade 10,
depositing an intermediate layer 26 on at least one portion of the inner layer 24, and
depositing an outer layer 28 on at least one portion of the intermediate layer 26.

The layers (24, 26, 28) may be applied by brushing, dip-coating, spraying, electrostatic coating, Langmuir-Blodgett transfer or any other technique known to those skilled in the art.

In order to avoid the risks and drawbacks linked to the use of organic solvents, especially their toxicity and their dangerousness when being handled, in particular in the case of an application by spraying, the layers (24, 26, 28) of the coating may be in the aqueous phase, i.e. comprising a content of organic solvents of less than or equal to 10% by total weight of the composition, or even less than or equal to 5%, or even equal to 0%.

Advantageously, the composition of the inner layer 24 deposited on the blade 10 comprises:
between 5 and 50% of binder,
0% of lubricating fillers,
between 0 and 5% of additives,
between 0 and 10% of crosslinking agent,
water q.s. for 100%.

In the embodiments in which the inner layer 24 comprises adhesive particles, the composition of the inner layer 24 deposited on the blade 10 comprises:
between 15 and 50% of adhesive particles,
0% of lubricating fillers,
between 0 and 5% of additives,
0% of crosslinking agent,
water q.s. for 100%.

Advantageously, the composition of the intermediate layer 26 deposited on the inner layer 24 comprises:
between 0.1 and 50% of binder,
between 1 and 80% of lubricating fillers,
between 0 and 5% of additives,
between 0 and 10% of crosslinking agent,
water q.s. for 100%.

Advantageously, the composition of the outer layer 28 deposited on the intermediate layer 26 comprises:
between 0 and 50% of binder,
between 1 and 80% of lubricating fillers,
between 0 and 5% of additives,
between 0 and 10% of crosslinking agent,
water q.s. for 100%.

The layers (24, 26, 28) may be applied by brushing, dip-coating, spraying, electrostatic coating or any other technique known to those skilled in the art. The adhesive particles are preferably applied by spraying or by electrostatic spray gun after dispersion of the particles in solution.

In order to promote the evaporation of the water, the various layers (24, 26, 28) may be applied to a hot blade.

Advantageously, the intermediate layer 26 is applied when the inner layer 24 is dry to the touch, similarly the outer layer 28 is applied when the intermediate layer 26 is dry to the touch.

A curing step may take place between the application of each of the layers (24, 26, 28) or after the application of the three layers (24, 26, 28) of the coating 20. This curing may take place by infrared radiation (in an oven or with a lamp), in a traditional oven or by any other method known to those skilled in the art.

In general, the temperature and the duration of said curing are adapted to the type of heating. The temperature is generally between 100 and 250° C. and may last between 0.1 and 10 min. In the case of infrared curing, the temperature is around 140° C. and the curing preferably lasts around 30 seconds. In the case of curing in a conventional oven, especially in the case of moulded wiper blades, the temperature is around 140° C. and the curing lasts around 5 to 10 min.

In certain embodiments in which at least one of the layers (24, 26, 28) is applied before the vulcanization, the curing step may be the vulcanization step. In this case, the temperature is around 200° C. for around 1 to 3 min.

In the embodiments in which the inner layer 24 is a UV-crosslinkable varnish, the crosslinking is carried out by UV irradiation before the application of the intermediate layer 26.

The process may comprise a preliminary step of surface preparation of the wiper blade 10. This step may be, for example, a plasma treatment, a halogenation or an ion implantation.

The wiper blade 10 may be obtained by extrusion or by moulding. It may also be obtained from a pair 30 of wiper blades, represented in FIG. 3.

This pair 30 may, for example, be obtained by a step of extruding material based on elastomer(s) 18 or by moulding. The pair 30 comprises two blades that are extruded together and are attached to one another via the ends 14a of the lips 14 of these blades, by means of a sacrificial linking element 32.

Each face of the pair 30 is subjected to a coating step described above during which an inner layer 22, an intermediate layer 24 and an outer layer 28 are applied successively to at least one portion of the wiper blades 10. This coating 20 is deposited in particular at the location where the lip 14 will be pre-split (A).

The coating step is then followed by a pre-splitting step, that is to say that with the aid of a cutting tool, a notch in the pair is made on each side of the pair, in line with the link between the lip 14 of each wiper blade 10 and the sacrificial linking element 32 while leaving a portion of this link uncut. Thus, each blade 10 is attached to the sacrificial linking element 32 by a “bridge” of material that may be easily cut but that is strong enough to allow handling of the pair 30 without the two wiper blades 10 separating.

Finally, in a cutting step, each blade 10 is separated from the sacrificial linking element 32 by cutting the bridge of material. Thus, two blades 10 are obtained comprising a material based on elastomer(s) 18, the outer surface of which is coated, at least partly, with a coating 20 according to the invention.

It will be noted that the surface of the wiper blade 10 based on elastomer(s) 18 may be partially or completely coated with the coating 20, that the layers (24, 26, 28) are applied to a wiper blade 10 or to a pair 30 of wiper blades. In particular, the end 14a of the lip may not be covered with coating 20 in order to enable a good wiping of the windscreen, in particular if the coating 20 is applied to a pair 30 of wiper blades before the pre-splitting step. Similarly, the coating at the hinge 16 may be free of intermediate layer 26 in order to retain a certain flexibility, as described in the aforegoing. In this case, the intermediate layer 26 is applied only to the lip 14, for example, by means of a brush or else a mask.

### EXAMPLES

Examples of the coating 20 and of the process are given here by way of illustration, the invention being in no way limited thereto.

In a first step, a commercial bonding primer (Daotan TW 6431) is applied by spraying to a vulcanized wiper blade pair 30 in order to form an inner layer 24 having a thickness of around 2 μm. Slight drying is carried out in order to have a surface appearance that is dry to the touch.

In a second step, a composition A in accordance with the invention is applied by spraying to the inner layer 24 in order to form an intermediate layer 26 having a thickness of around 4 μm. Slight drying is carried out in order to have a surface appearance that is dry to the touch.

The composition A comprises, per 100 g of product:
22.3 g of binder (Neocryl XK 90),
10 g of graphite lubricating fillers,
1 g of additives (0.5 g of Natrosol® 250 HBR and 0.5 g of BYK 349), and
66.7 g of water.

In a third step, a composition B in accordance with the invention is applied by spraying to the second layer in order to form an outer layer having a thickness of around 4 um.

The composition B comprises, per 100 g of product:
4.1 g of binder (Neocryl XK 90),
10 g of graphite lubricating fillers,
0.8 g of additives (0.3 g of Natrosol® 250 HBR and 0.5 g of BYK 349), and
85.1 g of water.

In a fourth step, the whole of the part is dried by an infrared lamp at a temperature of 140° C., for 30 seconds.

The pair 30 is split so as to obtain two wiper blades 10. These are covered with a coating 20 where:
the intermediate layer 26 comprises by dry weight (relative to the dry weight of the layer):
   47.8% of binder (Neocryl XK 90),
   47.6% of graphite lubricating fillers,
   4.6% of additives (2.4% of Natrosol® 250 HBR and 2.2% of BYK 349),
   i.e. a ratio of lubricating fillers to binder of 1;
the outer layer 28 comprises by dry weight (relative to the dry weight of the layer):
   14.6% of binder (Neocryl XK 90),
   79.3% of graphite lubricating fillers,
   6.1% of additives (2.4% of Natrosol® 250 HBR and 3.7% of BYK 349),
   i.e. a ratio of lubricating fillers to binder of 5.4.

It should be noted that embodiment variants are of course possible and that the present invention is not limited to windscreen wiper blades that have a coating where the layers have the compositions given in the example. In particular, it is possible to extend the present invention to other types of lubricating fillers, other lubricants and/or other additives known to those skilled in the art in order to obtain wiper blades that have the desired properties.

1. A wiper blade for windscreen wiper, comprising
a substrate made of material based on elastomer(s) covered at least partly by a coating having at least three superposed layers, referred to respectively as the inner layer, intermediate layer and outer layer,
the inner layer forming a bonding primer for bonding to the intermediate layer and comprising a lubricating filler content of substantially zero, and the intermediate layer having a non-zero lubricating filler content that is lower than that of the outer layer.

2. The wiper blade according to claim 1, in which the content of lubricating fillers in the intermediate layer is between 40 and 75% by dry weight.

3. The wiper blade according to claim 1, in which the content of lubricating fillers in the outer layer is between 70 and 100% by dry weight.

4. The wiper blade according to claim 1, in which the thickness of the inner layer is between 0.05 μand 4 μm, and/or thickness of the intermediate layer is between 1 and 5 μm, and/or the thickness of the outer layer is greater than 2 μm.

5. The wiper blade according to claim 1, in which the inner layer, the intermediate layer, and optionally the outer layer, comprise at least one binder.

6. The wiper blade according to claim 1, in which the inner layer comprises at least one adhesion promoting agent and/or at least one mechanical reinforcing agent and/or at least one crosslinking agent.

7. The wiper blade according to claim 1, in which the outer layer comprises at least one binder.

8. The wiper blade according to claim 1, in which the inner layer has an elongation at break of greater than 20%.

9. The wiper blade according to claim 1, in which the inner layer has a Young's modulus at 1% elongation of less than 5 MPa, and/or the intermediate layer has a Young's modulus at 1% elongation of greater than 25 MPa.

10. The wiper blade according to claim 1, comprising a lip connected to a hinge, the coating being free of intermediate layer at said hinge.

11. A process for manufacturing a wiper blade for windscreen wiper from a pair of wiper blades, said process comprising:
a step of coating, at least partly, said blade or pair, comprising the substeps of:
depositing an inner layer on at least one portion of the blade or pair,
depositing an intermediate layer on at least one portion of the inner layer, and
depositing an outer layer on at least one portion of the intermediate layer,
the inner layer forming a bonding primer and comprising a lubricating filler content of substantially zero, and
the intermediate layer having a non-zero lubricating filler content that is lower than that of the outer layer.

12. The process according to claim 11, in which at least one of the layers deposited is in the aqueous phase.

13. The process according to claim 11, further comprising a preliminary step of surface preparation of the blade or pair and/or at least one step of curing the blade or pair.

14. The process according to claim 1, in which said wiper blade or said wiper blades of the pair respectively comprise a lip connected to a hinge, said intermediate layer being applied only to said lip.

15. The process according to claim 11, in which the layers are applied to a pair of wiper blades, which pair is then cut to form two wiper blades.
